(19) United States
(12) Patent Application Publication
(10) Pub. No.: US 2011/0056809 A1
(43) Pub. Date: Mar. 10, 2011

(54) SYSTEM FOR BLOWING PLASTIC CONTAINERS, SPECIFICALLY BOTTLES

(75) Inventors: Maurizio Borgatti, Imola (IT); Fiorenzo Parrinello, Medicina (IT); Emilio Re, Ancona (IT); Gabriele Stocchi, Parma (IT)

(73) Assignee: SACMI COOPERATIVA MECCANICI IMOLA SOCIETA' COOPERA, Imola (Bologna) (IT)

(21) Appl. No.: 12/990,527

(22) PCT Filed: May 26, 2009
(86) PCT No.: PCT/IB2009/052203

§ 371 Date: Nov. 1, 2010

(30) Foreign Application Priority Data
May 28, 2008 (EP) 08425384.8

(51) Int. Cl. B65G 47/86; B65G 29/00; B29C 49/42

(52) U.S. Cl. 198/803.3

(57) ABSTRACT

A plant for blow-moulding plastic containers (2) from respective parisons (3) comprises a plurality of moulding units (10), each having a mould (11) for blow-moulding at least one container (2) and at least one stretching rod (14) that moves under the action of a drive device (16) in such a way as to axially deform a respective parison (3); the drive device (16) comprises, for each moulding unit (10) drive motor (17) coupled to the stretching rods (14) of the moulding unit (10) itself.

### TECHNICAL FIELD

This invention relates to a plant for blow-moulding plastic containers, particularly bottles.

### BACKGROUND ART

In the bottling industry, prior art plant of the type described, for example in patent applications EP-1445090-A1 and WO-0224435-A1, used for making plastic bottles, comprises: a blow-moulding wheel mounted in such a way as to rotate about a first longitudinal axis and equipped with a plurality of blow-moulding units, each of which is rotationally fed by the blow-moulding wheel about the first axis, comprises a mould for blow-moulding at least one bottle from a respective parison, and cooperates with at least one stretching rod designed to axially deform the parison.

Generally speaking, the stretching rods are moved along a line parallel to the first axis by a drive device comprising a first cam and, for each stretching rod, a respective first tappet roller engaged in the first cam itself.

The plant further comprises: an oven for thermally conditioning the parisons; a first feed device for advancing the parisons through the oven; a first transfer wheel mounted rotatably about a second longitudinal axis to transfer the parisons one after the other from the first feed device to the blow-moulding wheel; and a second transfer wheel mounted rotatably about a third longitudinal axis to transfer the bottles one after the other from the blow-moulding wheel to a second device for feeding the bottles to a bottle filling device or to another conveying device.

Usually, each transfer wheel comprises: a drum mounted to rotate about a respective second or third axis; a plurality of pick-up and transporting units, each of which is mounted on the drum to feed a respective parison or a respective bottle about the respective second or third axis, comprises a supporting arm rotatably coupled to rotate, relative to the drum, about a respective fourth axis, and is further equipped with a pick-up member rotatably coupled to the supporting arm to rotate, relative to the supporting arm, about a respective fifth axis; and an orienting device designed to orient the pick-up and transporting units about the respective fourth and fifth axes.

The orienting device comprises a second and a third cam and, for each pick-up and transporting unit, a second tappet roller mounted on the respective supporting arm and engaged in the second cam, and a third tappet roller mounted on the respective pick-up member and engaged in the third cam.

The orientation of the pick-up and transporting units about the respective fourth and fifth axes makes it possible to correctly transfer the parisons and the bottles, respectively, from the first feed device to the blow-moulding wheel and from the blow-moulding wheel to the second feed device according to the spacing of the parisons along the first feed device, the spacing of the moulding units and the spacing of the bottles along the second feed device.

Prior art bottle blow-moulding plants of the type described above are not, however, free of disadvantages due mainly to the fact that the passage from parisons and bottles of a first size to parisons and bottles of a second size, different from the first size, necessitates each time replacing the first, second and third cams, creating serious difficulties for personnel in charge and involving relatively long plant set-up times.

### AIM OF THE INVENTION

This invention has for an aim to provide a blow-moulding plant for making plastic containers, particularly bottles, that is free of the above mentioned disadvantages and that is simple and inexpensive to implement.

Accordingly, this invention provides a plant for blow-moulding plastic containers, particularly bottles, as described in the appended claims.

### BRIEF DESCRIPTION OF THE DRAWINGS

The invention will now be described with reference to the accompanying drawings which illustrate a preferred, non-limiting embodiment of it and in which:

FIG. 1 is a schematic plan view, with, some parts cut away for clarity, of a preferred embodiment of the plant according to the invention;

FIG. 2 is a schematic plan view, with some parts cut away for clarity, of a first detail of the plant of FIG. 1;

FIG. 3 is a schematic side view, with some parts cut away for clarity, of the detail of FIG. 2;

FIG. 4a is a schematic plan view, with some parts cut away for clarity, of another embodiment of the detail of FIGS. 2 and 3, illustrated in a first operating position;

FIG. 4b is a schematic plan view, with some parts cut away for clarity, of another embodiment of the detail of FIGS. 2 and 3, illustrated in a second operating position;

FIG. 5a is a schematic side view, with some parts cut away for clarity, of a second detail of the plant of FIG. 1, illustrated in a first operating position;

FIG. 5b is a schematic side view, with some parts cut away for clarity, of the detail of FIG. 5a, illustrated in a second operating position;

FIG. 6 is a schematic side view, with some parts cut away for clarity, of another embodiment of the detail of FIG. 5;

FIG. 7a is a schematic side view, with some parts cut away for clarity, of the detail of FIG. 5a made according to a second embodiment;

FIG. 7b is a schematic side view, with some parts cut away for clarity, of the detail of FIG. 5b made according to a second embodiment.

### DETAILED DESCRIPTION OF THE PREFERRED EMBODIMENTS OF THE INVENTION

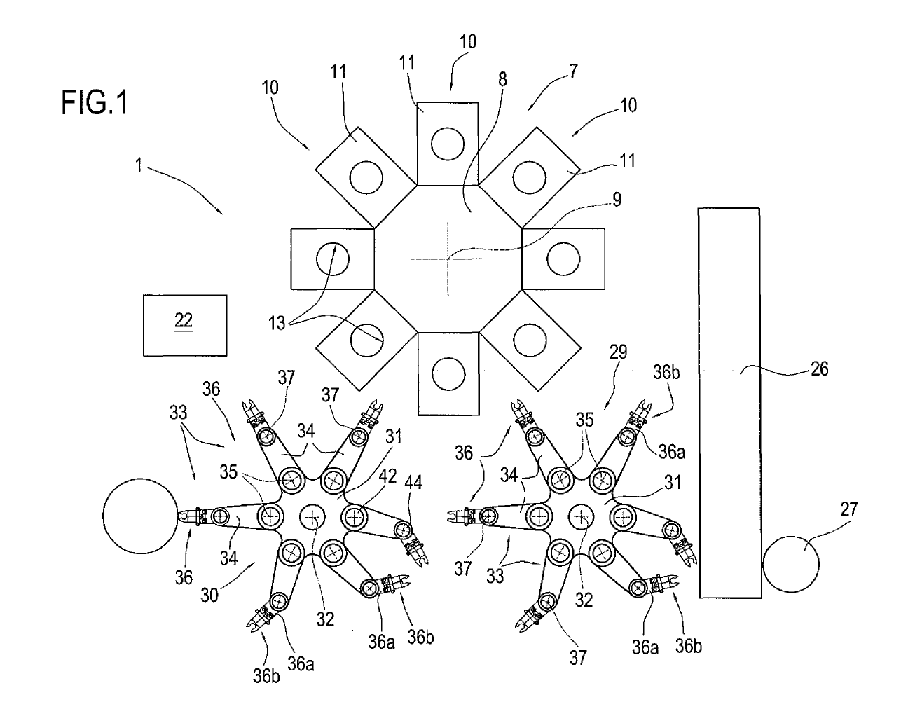

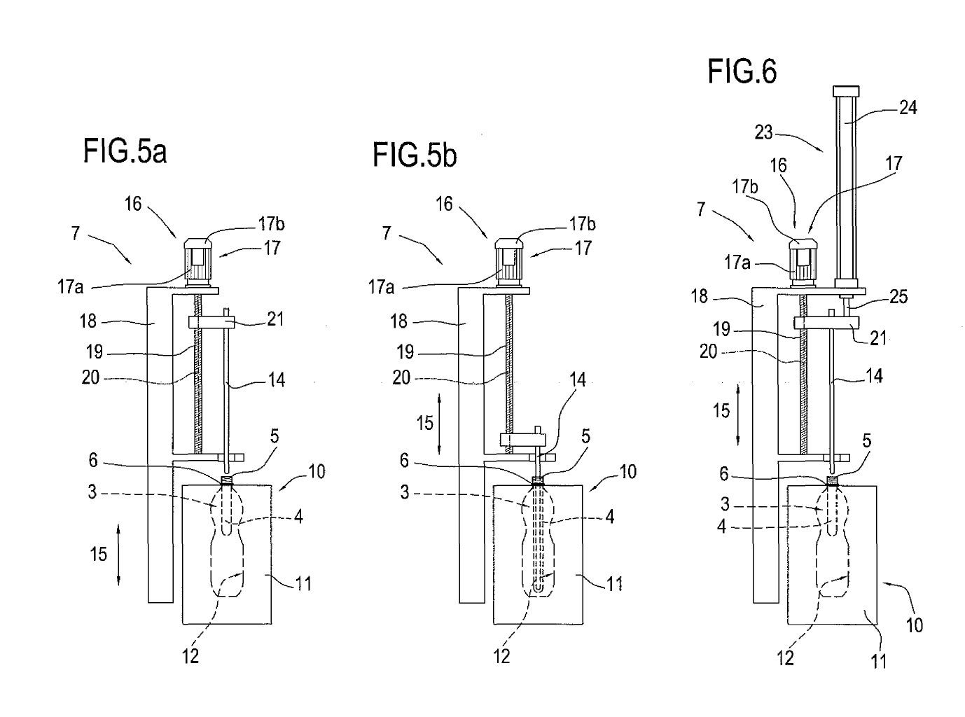

With reference to FIG. 1, the numeral 1 denotes in its entirety a plant for blow-moulding plastic containers, in this particular case, plastic bottles 2 (FIG. 3), from respective parisons 3 of known type (FIG. 5), each of which comprises an elongated cup-shaped body 4 having an externally threaded open end 5, and an annular neck 6 extending radially outwards from the outside surface of the body 4 itself.

The plant 1 comprises a blow-moulding machine 7 in turn comprising a blow-moulding wheel 8 mounted in such a way as to rotate continuously about its longitudinal axis 9, which is substantially vertical and at right angles to the drawing plane of FIG. 1, and a plurality of moulding units 10 which are mounted round the edge of the wheel 8, are uniformly distributed around the axis 9 according to a predetermined spacing, and are advanced by the wheel 8 around the axis 9.

Each unit 10 comprises a mould 11 in turn comprising two half-moulds of known type, not illustrated, that move between an open position where the half-moulds (not illustrated) are positioned at a predetermined distance from each other to receive a parison 3 or release a bottle 2, and a closed position, where the half-moulds (not illustrated) form inside them at least one moulding cavity 12 having the shape of a bottle 2 and being open to the outside at a hole 13 at the top of it smaller in diameter than a neck 6, and acting in conjunction with a pneumatic device of known type, not illustrated, designed to blow compressed air into the parison 3 inside the cavity 12.

As illustrated in FIG. 5, each cavity 12 acts in conjunction with a respective stretching rod 14 which extends along a vertical line 15 parallel to the axis 9, is mounted at a position coaxial with the cavity 12 and is mobile along the line 15 between a raised position (FIG. 5a), where the rod 14 is located substantially outside the respective parison 3, and a lowered position (FIG. 5b), where the rod 14 engages the respective parison 3 in such a way as to stretch it axially along the line 15.

The stretching rods 14 are moved along the line 15 by a drive device 16 comprising, for each stretching rod 14, a respective drive motor 17 fixed to a mounting bracket 18 of the unit 10, and having an output shaft 19 that is mounted to rotate about a longitudinal axis 20 parallel to the line 15, is coupled by a lead nut and screw mechanism to a plate 21 on which the stretching rod 14 itself is mounted and is rotationally driven by the motor 17 so as to move the stretching rod 14 in a straight line between its raised and lowered positions.

More specifically, each drive motor 17 comprises an electric motor 17a (in this particular case, a brushless electric motor) and a control encoder 17b connected, together with the encoders 17b of the other electric motors 17a, to an electronic control unit 22 designed to control the operation of the motors 17 and, hence, the movement of the stretching rods 14 along the line 15 according to the size of the parisons 3, that is to say, according to the dimensions and/or shape of the parisons 3.

In other embodiments which are not illustrated, the lead nut and screw coupling is eliminated and, instead, there is, for example, a transmission belt system and each drive motor 17 comprises a linear motor.

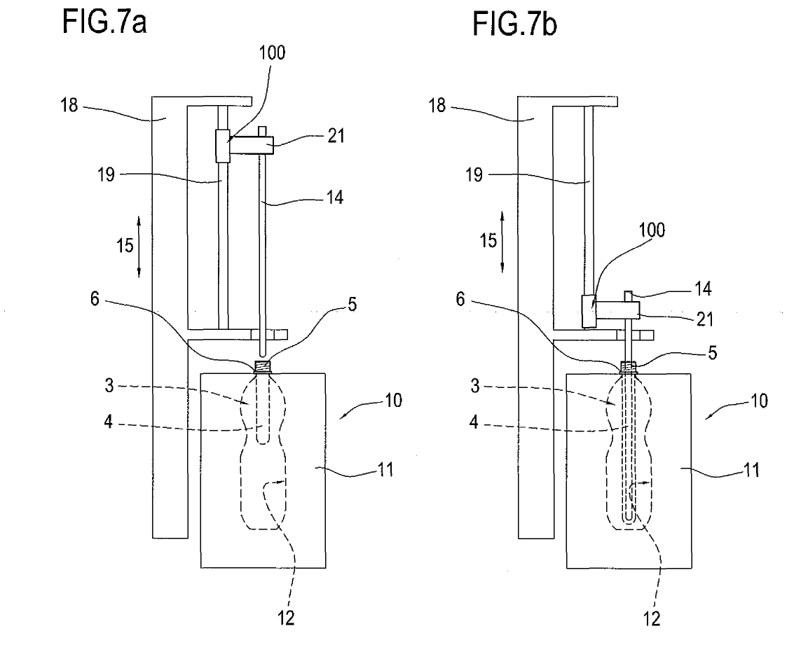

In the embodiment illustrated in FIGS. 7a and 7b, the stretching rod 14 is connected directly to a linear electric motor 100 which moves it vertically.

The motor 100 might also be of the non-linear type.

The use of the linear electric motor 100 allows the stretching rods 14 to be driven at very high speeds.

More in detail, the stretching rod 14 moves vertically at an average speed of up to more than 1.5 metres per second.

In a first configuration of the plant, the stretching rod 14 moves vertically at an average speed of between 1.5 and 3 metres per second.

In a second configuration of the plant, the stretching rod 14 moves vertically at an average speed of between 3 and 6 metres per second.

This is an extremely advantageous aspect: in fact, it has been observed that stretching the parisons 3 at high speed has a strain hardening effect on the plastic the bottles 2 are made of and improves the mechanical properties of the material.

In this way, the quantity of plastic used to make a bottle 2 can be further reduced, allowing significant savings in terms of bottle 2 production cost and lessening the environmental impact of the plant.

Increasing the stretching speed of the rods 14 also means that the pressure of the fluid used for blow-moulding the parisons 3 can be less than 30 bar.

In particular, the fluid can be applied at a pressure of between 7 and 25 bar.

This is made possible by the high stretching speed imparted to the rods 14.

The embodiment illustrated in FIG. 6 differs from the one illustrated in FIG. 5 only in that, for moving the respective rod 14 from the raised to the lowered position, each motor 17 acts in conjunction with a respective pushing device 23 comprising, in this particular case, a pneumatic compensation cylinder 24 having an output rod 25 fixed at a free end of it to the respective plate 21.

With reference to FIG. 1, the plant 1 further comprises an oven 26 of known type for thermally conditioning the plastic material of the parisons 3 to a temperature greater than its glass transition temperature; a feed wheel 27 of known type for feeding the parisons 3 to the oven 26; a first transfer wheel 29 for transferring each parison 3 from the oven 26 to a respective moulding unit 10; and a second transfer wheel 30 for transferring each bottle 2 from the respective moulding unit 10 to a customary feed line, not illustrated, of a customary plant, not illustrated, for filling the bottles 2, or to a bottle 2 outfeed line (not illustrated).

Each wheel 29, 30 comprises a drum 31 mounted to turn continuously about its substantially vertical longitudinal axis 32 parallel to the line 15, and a plurality of pick-up and transporting units 33 (in this particular embodiment six pick-up and transporting units 33) that are mounted along a peripheral edge of the drum 31, protrude radially outwards from the drum 31, and are advanced by the drum 31 itself around the axis 32.

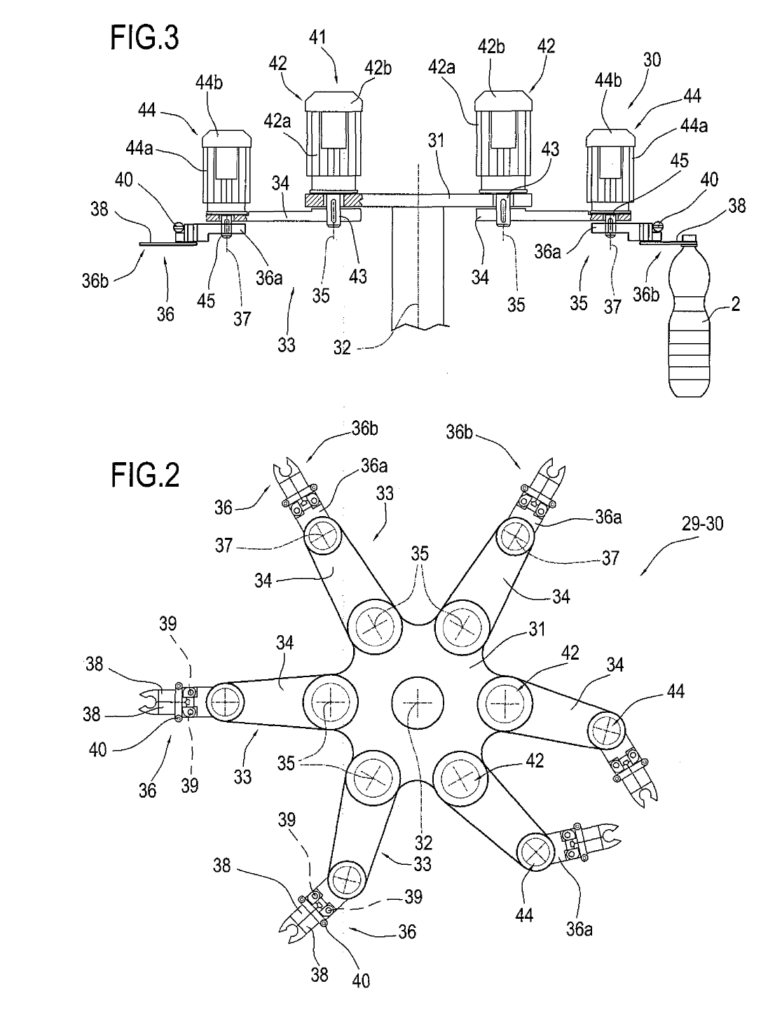

As illustrated in FIGS. 2 and 3, each unit 33 comprises a supporting arm 34 that extends transversally of the axis 32, is hinged to the drum 31 to rotate, relative to the drum 31 itself, about a pivot axis 35 substantially parallel to the line 15, and mounts a pick-up member 36 which extends transversally of the axis 32 and which comprises a crank lever 36a hinged to the arm 34 to rotate, relative to the arm 34 itself, about a pivot axis 37 substantially parallel to the line 15.

The member 36 also comprises a pick-up element 36b having the shape of a fork and in turn comprising two arms 38 which are mounted to oscillate about respective pivot axes 39 parallel to the line 15 between a position of releasing (not illustrated) and a position of clamping (FIG. 2) a respective bottle 2 or a respective parison 3, and which a spring 40 interposed between the arms normally holds in the clamping position where the arms 38 grip it.

The units 33 are oriented about the respective axes 35 and 37 by an actuating device 41 comprising, for each unit 33, a respective first drive motor 42 that is mounted on the drum 31 and has an output shaft 43 which is parallel to the line 15 and which the respective arm 34 is keyed to, and a respective second drive motor 44 that is fixed to the respective arm 34 and has an output shaft 45 which is parallel to the line 15 and which the respective crank lever 36a is keyed to.

In use, rotation of the wheels 29, 30 about the respective axes 32 and simultaneous orientation of the supporting arms 34 about the axes 35 and of the pick-up members 36 about the axes 37 enables the wheel 29 to receive the parisons 3 according to the spacing of the oven 26 and to release them to the blow-moulding machine 7 according to the spacing of the moulding units 10, and enables the wheel 30 to receive the bottles 2 according to the spacing of the moulding units 10 and to release them to the above mentioned filling plant (not illustrated) according to the spacing of the above mentioned feed line (not illustrated) or to the above mentioned outfeed line (not illustrated) according to the spacing of the outfeed line itself (not illustrated).

More specifically, each drive motor 42, 44 comprises an electric motor 42a, 44a (in this particular case, a brushless electric motor) and a control encoder 42b, 44b connected, together with the encoders 42b, 44b of the other electric motors 42a, 44a, to the electronic control unit 22 designed to control the operation of the motors 42, 44 and, hence, the orientation of the pick-up and transporting units 33 about the respective axes 35, 37 according to the size of the bottles 2 and of the parisons 3.

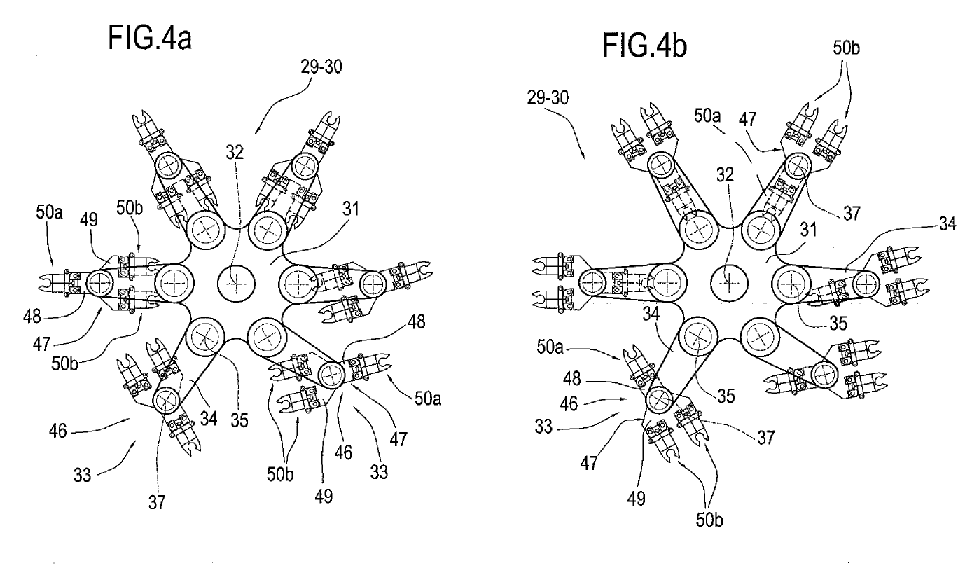

The embodiment illustrated in FIG. 4 differs from the one illustrated in FIGS. 2 and 3 only in that the pick-up members 36 are eliminated and each substituted by a respective pick-up unit 46 which comprises a rocker arm 47 hinged to the respective arm 34 to rotate about the axis 37 and which in turn comprises a first and a second arm 48, 49 opposite each other, the arm 48 being equipped with a pick-up element 50a, similar to the elements 36b, and the arm 49 being equipped with two pick-up elements 50b that are similar to the elements 36b, are parallel to each other and to the element 50a and have concavities opposite the concavity of the element 50a itself.

In use, the drive motors 44 allow the pick-up units 46 to be selectively oriented about the respective axes 37 according to the size of the bottles 2 to be blow-moulded and/or the number of moulding cavities 12 in each mould 11. In particular, the pick-up elements 50a are moved towards the outside of the respective wheel 29, 30 to an operating position and the pick-up elements 50b are moved towards the inside of the respective wheel 29, 30 to a rest position (FIG. 4a) when each mould 11 has a single moulding cavity 12 for blow-moulding a single bottle 2, while the pick-up elements 50a are moved towards the inside of the respective wheel 29, 30 to a rest position and the pick-up elements 50b are moved towards the outside of the respective wheel 29, 30 to an operating position (FIG. 4b) when each mould 11 has two moulding cavities 12 for blow-moulding two bottles 2.

In another embodiment that is not illustrated, each supporting arm 34 is slidably coupled to the respective drum 31 and each pick-up member 36 or pick-up unit 46 is slidably coupled to the respective supporting arm 34. Alternatively, one of the elements of each pick-up and transporting unit 33 is slidable while the other element of each pick-up and transporting unit 33 is rotatable.

In a further possible embodiment that is not illustrated, the orienting device 41 comprises a pick-up and transporting unit 33, a first drive motor 42 for moving the coupling element 34, while the pick-up member 36; 46 is driven by kinematic couplings such as cams or sliders.

Alternatively, in a yet further possible embodiment that is not illustrated, the orienting device 41 comprises, for each pick-up and transporting unit 33, a first drive motor 42 for moving the pick-up member 36; 46, while the coupling element 34 is driven by kinematic couplings such as cams or sliders.

1) A plant for blow-moulding plastic containers (2), particularly bottles from respective parisons (3), the plant comprising: a blow-moulding wheel (8) mounted to rotate about a first longitudinal axis (9); a plurality of moulding units (10), each of which is fed by the blow-moulding wheel (8) about the first axis (9), is equipped with a mould (11) for blow-moulding at least one container (2) from a respective parison (3) and comprises at least one stretching rod (14) designed to engage the parison (3) in such a way as to axially deform the parison (3); and a drive device (16) for moving the stretching rods (14) along a line parallel to the first axis (9); and being characterized in that the drive device (16) comprises, for each moulding unit (10), a respective drive motor (17) coupled to the stretching rods (14) of the moulding unit (10) itself.

2) The plant according to claim 1, wherein each drive motor (17) has an output shaft (19) mounted to rotate about a second, longitudinal axis (20) and coupled to the respective stretching rods (14) by a lead nut and screw mechanism.

3) The plant according to claim 1 or 2, wherein each drive motor (17) comprises an electric motor (17a).

4) The plant according to claim 3, wherein each drive motor (17) also comprises an encoder (17b ) for controlling the operation of the respective electric motor (17a).

5) The plant according to any of the foregoing claims and further comprising a logic control device (22) for controlling the operation of each drive motor (17) according to the size of the parisons (3).

6) The plant according to any of the foregoing claims, wherein each stretching rod (14) is mobile between a raised position and a lowered position; the drive device (16) further comprising, for each moulding unit (10), respective pushing means (23) acting in conjunction with the respective drive motor (17) to move the respective stretching rods (14) to the lowered positions.

7) The plant according to claim 6, wherein the pushing means (23) comprise a pneumatic cylinder (24) having an output rod (25) coupled to the respective stretching rods (14).

8) The plant according to any of the foregoing claims, wherein the blow-moulding wheel (8) is mounted to rotate continuously about the first axis (9).

9) The plant according to claim 1, characterized in that the drive motor is a linear electric motor (100).

10) The plant according to claim 9, characterized in that the stretching rod (14) is connected directly to the linear electric motor (100).

11) A method for blow-moulding plastic containers in a plant according to any of the foregoing claims from 1 to 10, comprising the steps of:
stretching the at least one parison (3) using the stretching rod (14);
moulding the container (2) by blowing a fluid under pressure into the mould (11), characterized in that the step of stretching the parison (3) is accomplished by moving the stretching rod (14) at an average speed greater than 1.5 metres per second at least at a point in the vertical movement of the stretching rod (14) itself.

12) The method according to claim 11, characterized in that the step of stretching the parison (3) is accomplished by moving the stretching rod (14) at an average speed of between 1.5 and 3 metres per second.

13) The method according to claim 11, characterized in that the step of stretching the parison (3) is accomplished by moving the stretching rod (14) at an average speed of between 3 and 6 metres per second.

14) The method according to any of the foregoing claims from 11 to 13, characterized in that the step of blowing a fluid under pressure into the mould (11) is accomplished by blowing a fluid in at a pressure of 30 bar.

15) The method according to claim 14, characterized in that the step of blowing a fluid under pressure into the mould (11) is accomplished by blowing a fluid in at a pressure of between 7 and 25 bar.

16) A transfer wheel for a plant for blow-moulding plastic containers (2), particularly bottles, from respective parisons (3), the transfer wheel comprising: a drum (31) mounted to rotate about a first longitudinal axis (32); a plurality of pick-up and transporting units (33), each of which is mounted on the drum (31) to feed a respective parison (3) or a respective container (2) about the first axis (32), is equipped with a pick-up member (36; 46), and comprises at least one element (34) for coupling the pick-up member (36; 46) to the drum (31); and an orienting device (41) for moving each coupling element (34) relative to the drum (31) and each pick-up member (36; 46) relative to the respective coupling element (34); and being characterized in that the orienting device (41) comprises, for each pick-up and transporting unit (33), a first drive motor (42) for moving one between the coupling element (34) and the pick-up member (36; 46).

17) The transfer wheel according to claim 16, characterized in that the orienting device (41) comprises, for each pick-up and transporting unit (33), a respective first drive motor (42) for moving one between the coupling element (34) and the pick-up member (36; 46), and a respective second drive motor (44) for moving the other between the coupling element (34) and the pick-up member (36; 46).

18) The transfer wheel according to claim 17, wherein each coupling element (34) has a supporting arm (34) rotatably coupled to the drum (31) to rotate, relative to the drum (31), about a respective second axis (35), and wherein each pick-up member (36; 46) is rotatably coupled to the respective supporting arm (34) to rotate, relative to the supporting arm (34) itself, about a respective third axis (37); each first drive motor (42) orienting the respective supporting arm (34) about the second axis (35) and each second drive motor (44) orienting the respective pick-up member (36; 46) about the third axis (37).

19) The transfer wheel according to claim 18, wherein the first, second and third axes (32, 35, 37) are substantially parallel to each other.

20) The transfer wheel according to any of the foregoing claims from 16 to 19, wherein each drive motor (42, 44) comprises an electric motor (42a, 44a).

21) The transfer wheel according claim 20, wherein each drive motor (42, 44) also comprises an encoder (42b, 44b) for controlling the operation of the respective electric motor (42a, 44a).

22) The transfer wheel according to any of the foregoing claims from 16 to 21 and further comprising a logic control device (22) for controlling the operation of each drive motor (42, 44).

23) The transfer wheel according to any of the foregoing claims from 16 to 22, wherein each pick-up member (36) comprises a single element (36b) for holding a parison (3) or a container (2).

24) The transfer wheel according to any of the foregoing claims from 16 to 22, wherein each pick-up member (46) comprises at least two elements (50a, 50b) for holding respective parisons (3) or respective containers (2).

25) The transfer wheel according to any of the foregoing claims from 16 to 22, wherein each pick-up member (46) comprises a first element (50a) for holding a parison (3) or a container (2) of a first size and two second elements (50b), opposite the first element (50a), for holding respective parisons (3) or respective containers (2) of a second size different from the first size.

26) A transfer wheel for a plant for blow-moulding plastic containers (2), particularly bottles, from respective parisons (3), the transfer wheel comprising: a drum (31) mounted to rotate about a first longitudinal axis (32); and a plurality of pick-up and transporting units (33), each of which is mounted on the drum (31) to feed at least one respective parison (3) or at least one respective container (2) about the first axis (32), and being characterized in that each pick-up and transporting unit (33) comprises at least one first and a second element (50a, 50b) for holding respective parisons (3) or respective containers (2), an orienting device (41) being provided for selectively moving the first and second elements (50a, 50b) between respective rest positions and respective operating positions.

27) The transfer wheel according to claim 26, wherein the orienting device (41) comprises, for each pick-up and transporting unit (33), a respective drive motor (44) for selectively moving the first and second elements (50a, 50b) between the respective rest positions and the respective operating positions.

28) The transfer wheel according to claim 26 or 27, wherein each pick-up and transporting unit (33) comprises a pick-up member (36; 46) equipped with the first and second elements (50a, 50b), and further comprises at least one element (34) for coupling the pick-up member (36; 46) to the drum (31).

29) The transfer wheel according to claim 28, and further comprising, for each pick-up and transporting unit (33), a respective first drive motor (42) for moving the respective coupling element (34) relative to the drum (31) and a respective second drive motor (44) for moving the respective pick-up member (36; 46) relative to the coupling element (34).

30) The transfer wheel according to claim 29, wherein each coupling element (34) comprises a supporting arm (34) rotatably coupled to the drum (31) to rotate, relative to the drum (31), about a respective second axis (35), and wherein each pick-up member (36; 46) is rotatably coupled to the respective supporting arm (34) to rotate, relative to the supporting arm (34) itself, about a respective third axis (37); the first and second drive motors (42, 44) orienting the respective supporting arm (34) and the respective pick-up member (36; 46) about the second and third axes (35, 37).

31) The transfer wheel according to claim 29 or 30, wherein each of the first and second drive motors (42, 44) comprises an electric motor (42a, 44a).

32) The transfer wheel according claim 31, wherein each of the first and second drive motors (42, 44) also comprises an encoder (42b, 44b) for controlling the operation of the respective electric motor (42a, 44a).

33) The transfer wheel according to any of the foregoing claims from 26 to 32, wherein the first and second elements (50a, 50b) are shaped and sized to hold respective parisons (3) or respective containers (2) of different sizes.
